(19) United States
(12) Patent Application Publication
(10) Pub. No.: US 2013/0347038 A1
(43) Pub. Date: Dec. 26, 2013

(54) SYSTEMS AND METHODS FOR SEARCHING FOR MEDIA BASED ON DERIVED ATTRIBUTES

(71) Applicant: Christopher Lee, West Chester, PA (US)

(72) Inventor: Christopher Lee, West Chester, PA (US)

(73) Assignee: United Video Properties, Inc., Santa Clara, CA (US)

(21) Appl. No.: 13/529,613

(22) Filed: Jun. 21, 2012

(51) Int. Cl. H04N 21/462

(52) U.S. Cl. 725/40

(57) ABSTRACT

Systems and methods described herein provide for generating disruptive recommendations based on a seed input. The viewer may receive recommendations having varying affinity between a media asset being currently viewed and the seed input. In some embodiments, the viewer interacts with a slider interface having the currently viewed media asset at one end and the seed input at the other, and an affinity indicator proximate to either end. The viewer may select a location of the affinity indicator on the slider for determining recommendations. The viewer may receive recommendations based on the currently viewed media asset and the seed input as the affinity indicator slides from one end of the slider interface to the other.

### BACKGROUND

Viewers today have a considerable range of media content available to them through various different television channels, subscription or Video-On-Demand (VOD) services, and different platforms such as Internet-based sources. One way for a viewer to discover content is recommendations for media content that may appeal to their interests. Such recommendations are typically based on the viewer's viewing activity. For example, a viewer that typically watches comedy programs may receive recommendations for additional comedy programs.

### SUMMARY OF THE DISCLOSURE

Typical recommendations based on the viewer's viewing activity may preclude other potential recommendations which may be of interest to the viewer. For example, a viewer may find a new drama program to be interesting if recommended, but may never receive such an option based on their viewing activity. Accordingly, the systems and methods described herein provide for generating disruptive recommendations based on a seed input. The seed input may be a media asset received from another viewer, received from the viewer's social network, chosen at random, or any other suitable media asset. The seed input may be a media asset that is “disruptive.” A disruptive seed input may have attribute data divergent from the currently viewed program, thereby allowing the viewer to discover new content. For example, a disruptive seed input may be a comedy program and divergent from a drama program being currently viewed. The described systems and methods allow the viewer to receive recommendations having varying affinity between a media asset being currently viewed by the user and the seed input. In some embodiments, the described systems and methods display a slider interface having the currently viewed media asset at one end and the seed input at the other, and an affinity indicator proximate to either end. The location of the affinity indicator may be used to determine an affinity measure that indicates affinity for the viewed media asset relative to the seed input. In some embodiments, the affinity measure is a probabilistic measure that weighs the viewed media asset relative to the seed input.

The described systems and methods may enable the viewer to select a location of the affinity indicator on the slider for determining recommendations. The viewer may receive recommendations having varying affinity between a media asset being currently viewed and the seed input as the affinity indicator slides from one end of the slider to the other. For example, a viewer currently viewing a comedy program may receive a seed input for a drama program. As the viewer changes location of the affinity indicator on the slider, they may receive varying viewing recommendations ranging in characteristics from the comedy program to the drama program.

In some aspects, the systems and methods described herein provide for a method implemented on control circuitry for generating viewing recommendations. The control circuitry retrieves from a memory viewed media attribute data representative of a media asset being currently viewed, and seed media attribute data representative of a seed media asset. The memory may be a memory local to the control circuitry or a remote memory such as memory of a remote server. The control circuitry generates a display including a slider that includes a first end associated with the viewed media asset, a second end associated with the seed media asset, and an affinity indicator proximate to one of the first and second ends. The control circuitry receives location information for the affinity indicator on the slider, and determines an affinity measure based on the location of the affinity indicator. The affinity measure indicates affinity for the viewed media asset relative to the seed media asset. The control circuitry retrieves listings for media assets based on the affinity measure, and generates a display including the listings for the media assets.

In some embodiments, the control circuitry applies the affinity measure to the viewed media attribute data and converse of the affinity measure to the seed media attribute data. The control circuitry combines results of the applications to form search attribute data. The control circuitry transmits a query to a database for media assets matching the search attribute data. The control circuitry receives the media assets from the database, and generates a display including the media assets and the search attribute data.

In some embodiments, the control circuitry retrieving seed media attribute data representative of the seed media asset includes the control circuitry retrieving from a database metadata associated the seed media asset, and determining the seed media attribute data based on the retrieved metadata.

In some embodiments, the location information of the affinity indicator is based on user input. In some embodiments, the location information of the affinity indicator is based on a distance between a first user device associated with the viewed media asset and a second user device associated with the seed media asset. In some embodiments, the media assets and the search attribute data are displayed on a display device associated with the first user device.

In some embodiments, the control circuitry determining the affinity measure based on the location information of the affinity indicator on the slider includes the control circuitry retrieving the affinity measure from a lookup table indexed using the affinity indicator.

In some embodiments, the control circuitry determines an updated affinity measure based on updated location information of the affinity indicator. The control circuitry further forms updated search attribute data based on the updated affinity measure, the viewed media attribute data, and the seed media attribute data.

In some embodiments, the control circuitry combining results of the applications to form search attribute data includes the control circuitry determining search attributes common to the applied viewed media attribute data and the applied seed media attribute data. The control circuitry adds respective data from the applied viewed media attribute data and the applied seed media attribute data to form the search attribute data. In some embodiments, the control circuitry stores attribute data not common to the applied viewed media attribute data and the applied seed media attribute data as extended search attribute data. The control circuitry adds respective data from the applied viewed media attribute data and the applied seed media attribute data to form the extended search attribute data.

In some embodiments, the control circuitry generating the display including the media assets and the search attribute data includes generating a display having a first region including media assets matching the search attribute data, and a second region including media assets matching the extended search attribute data.

In some embodiments, the seed media asset includes one of a media asset received from an individual, a media asset received from a social network, a randomly chosen media asset, or any other suitable media asset.

In some aspects, a system for generating viewing recommendations is implemented at least partially on user equipment including a user input interface, a display device, and control circuitry configured to execute the functionality described above.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the disclosure;

FIG. 3 shows an illustrative user equipment device in accordance with an embodiment of the disclosure;

FIG. 4 is a diagram of an illustrative cross-platform interactive media system in accordance with an embodiment of the disclosure;

FIG. 5A shows an illustrative user interface for generating viewing recommendations in accordance with an embodiment of the disclosure;

FIG. 5B shows an illustrative user interface for generating viewing recommendations in accordance with another embodiment of the disclosure;

FIG. 6 shows an illustrative flow diagram for generating viewing recommendations in accordance with an illustrative embodiment of the disclosure;

FIG. 7 shows an illustrative flow diagram for generating viewing recommendations in accordance with another illustrative embodiment of the disclosure;

FIG. 8 shows an illustrative flow diagram for determining an affinity measure as indicated in FIG. 6 or FIG. 7 in accordance with an embodiment of the disclosure;

FIG. 9 shows an illustrative flow diagram for forming search attribute data as indicated in FIG. 7 in accordance with an embodiment of the disclosure;

FIG. 10 shows an illustrative flow diagram for retrieving media assets for recommendation as indicated in FIG. 7 in accordance with an embodiment of the disclosure;

FIG. 11 shows an illustrative graph determining media assets matching seed media attribute data in accordance with an embodiment of the disclosure;

FIGS. 12A and 12B show illustrative diagrams for a system implementing the flow diagram of FIG. 7 in accordance with an embodiment of the disclosure; and

FIG. 13 shows an illustrative flow diagram for determining an affinity measure as indicated in FIG. 6 or FIG. 7 in accordance with another embodiment of the disclosure.

### DETAILED DESCRIPTION OF EMBODIMENTS

The systems and methods described herein provide for generating disruptive recommendations based on a seed input. The seed input may be a media asset received from another viewer, received from the viewer's social network, chosen at random, or any other suitable media asset. The seed input may be a media asset that is disruptive. A disruptive seed input may have attribute data divergent from the currently viewed program, thereby allowing the viewer to discover new content. For example, a disruptive seed input may be a comedy program and divergent from a drama program being currently viewed. The described systems and methods allow the viewer to receive recommendations having varying affinity between a media asset being currently viewed by the user and the seed input. In some embodiments, the described systems and methods display a slider interface having the currently viewed media asset at one end and the seed input at the other, and an affinity indicator proximate to either end. In some embodiments, the slider interface may be substituted or enhanced with a dial interface, a numerical entry field, or any other suitable interface. The location of the affinity indicator may be used to determine an affinity measure that indicates affinity for the viewed media asset relative to the seed input. In some embodiments, the affinity measure is a probabilistic measure that weighs the viewed media asset relative to the seed input.

The described systems and methods may allow the viewer to select a location of the affinity indicator on the slider for determining recommendations. The viewer may receive recommendations having varying affinity between a media asset being currently viewed and the seed input as the affinity indicator slides from one end of the slider to the other. For example, a viewer currently viewing a comedy program may receive a seed input for a drama program. As the viewer changes location of the affinity indicator on the slider, they may receive varying viewing recommendations ranging in characteristics from the comedy program to the drama program. For example, the characteristics may include attributes such as genre, title, rating, channel, release date, broadcast time, or any other suitable attribute.

Each attribute may have corresponding attribute data including the attribute category (e.g., genre), attribute value (e.g., comedy), and/or attribute factor (e.g., 5). For example, a comedy program may include attribute data for the attribute category “genre.” Furthermore, the attribute value for the genre attribute may be “comedy.” Furthermore, the attribute factor for given attribute value “comedy” may be “5.” The attribute factor may be used in computing additional data based on the genre attribute. In some embodiments, the attribute factor may have a range from a minimum value to a maximum value. For example, the attribute factor may vary from zero to 10. Attribute factor zero may correspond to programs having attribute value on one end of a spectrum, while attribute factor ten may correspond to programs having attribute value on the other side.

For example, attribute factor “0” on one end of the attribute category “genre” may correspond to attribute value “action,” while attribute factor “10” on the other end of the attribute category “genre” may correspond to attribute value “drama.” Furthermore, attribute factor “5” attribute value lies within the spectrum of attribute category “genre” and may correspond to attribute value “comedy.” In another example, the attribute factor may vary from zero to 6. Attribute factor “0” on one end of the attribute category “TV rating” may correspond to attribute value “TV-Y,” while attribute factor “6” on the other end of the attribute category “TV rating” may correspond to attribute value “TV-MA.” Furthermore, attribute factor “4” attribute value lies within the spectrum of attribute category “program rating” and may correspond to attribute value “TV-PG.” This definition of attribute data applies hereinafter in this disclosure, and applies to both viewed media attributes and seed media attributes. In some embodiments, functionality for providing viewing recommendations to a user may be implemented in an interactive media guidance application, the details for which are discussed further below.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

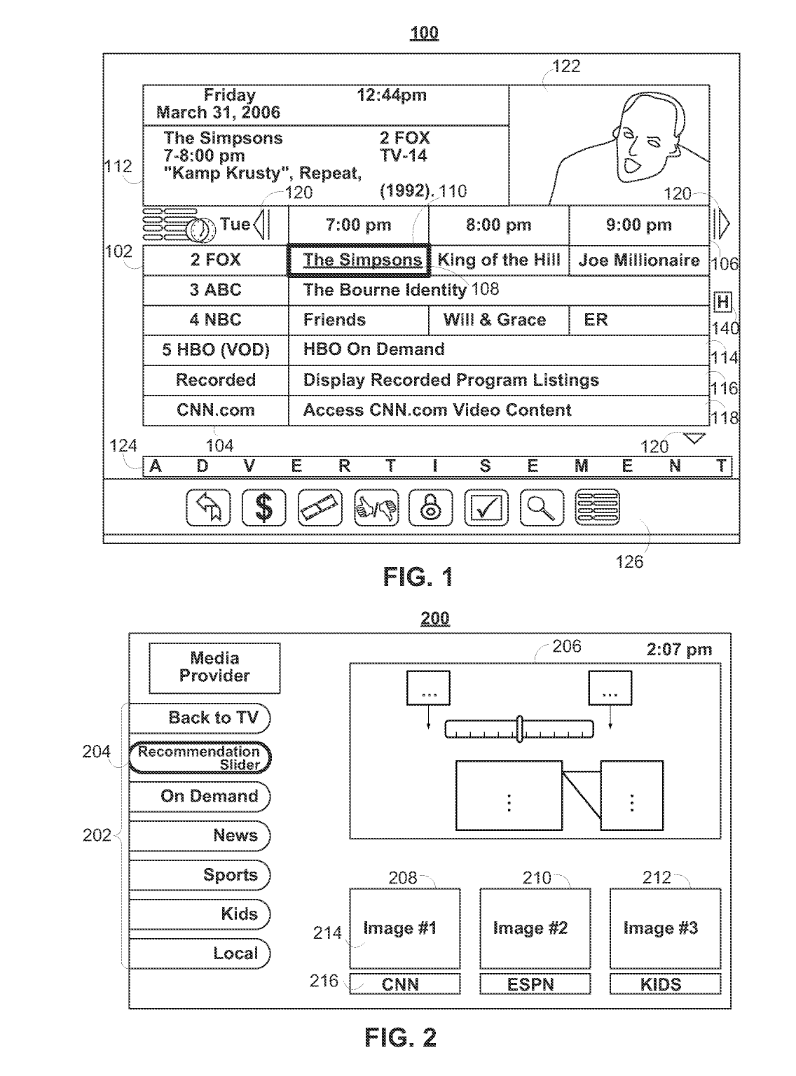

FIGS. 1-2 show illustrative display screens that may be used to provide media guidance data. The display screens shown in FIGS. 1-2 and 5A-9 may be implemented on any suitable user equipment device or platform. While the displays of FIGS. 1-2 and 5A-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your

Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, options to view related content based on attribute data for a selected media content, options to view the related content on a second screen device, options to view additional related content, options to add related content to a queue for later viewing, options to resume playback of the selected media content, options to specify an ordering scheme and/or criteria for the ordering scheme, or other suitable options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

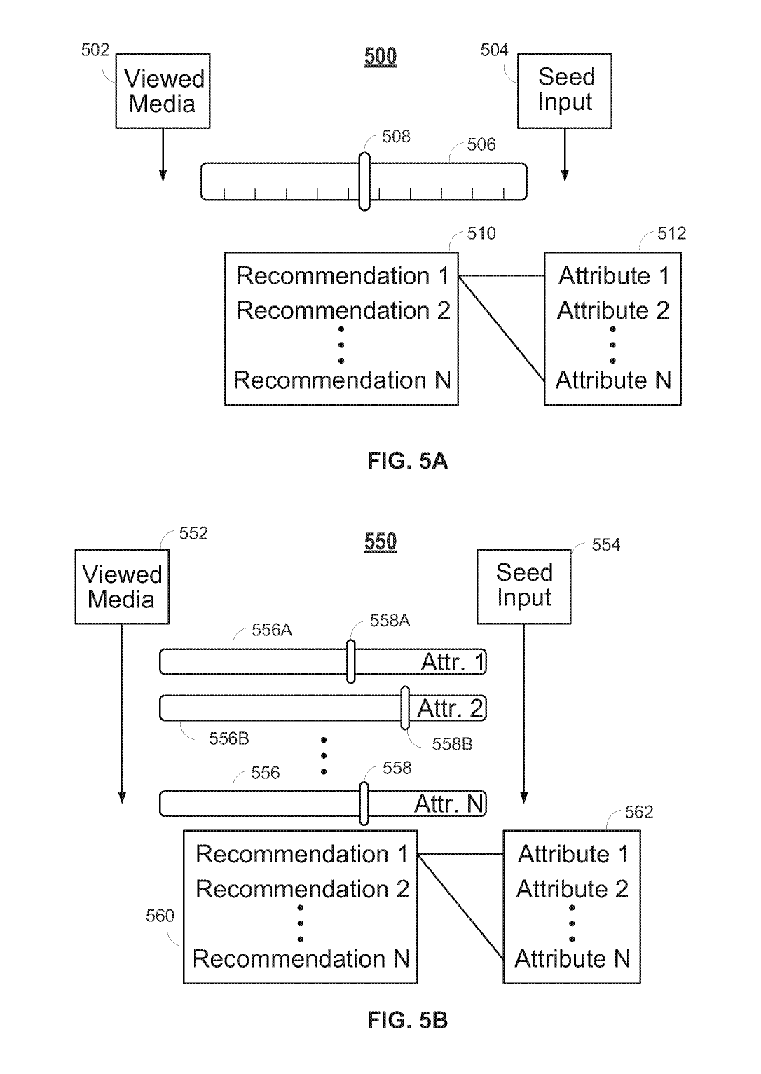

Another display arrangement for providing media guidance is shown in FIG. 2. Video mosaic display 200 includes selectable options 202 for content information organized based on content type, genre, and/or other organization criteria. In display 200, recommendation slider 204 is selected, thus providing user interface 206. Illustrative embodiments of user interface 206 are described with respect to FIGS. 5A and 5B. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 have similar sizes (i.e., listings 208, 210, and 212), but if desired, one or more listings may have different sizes. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

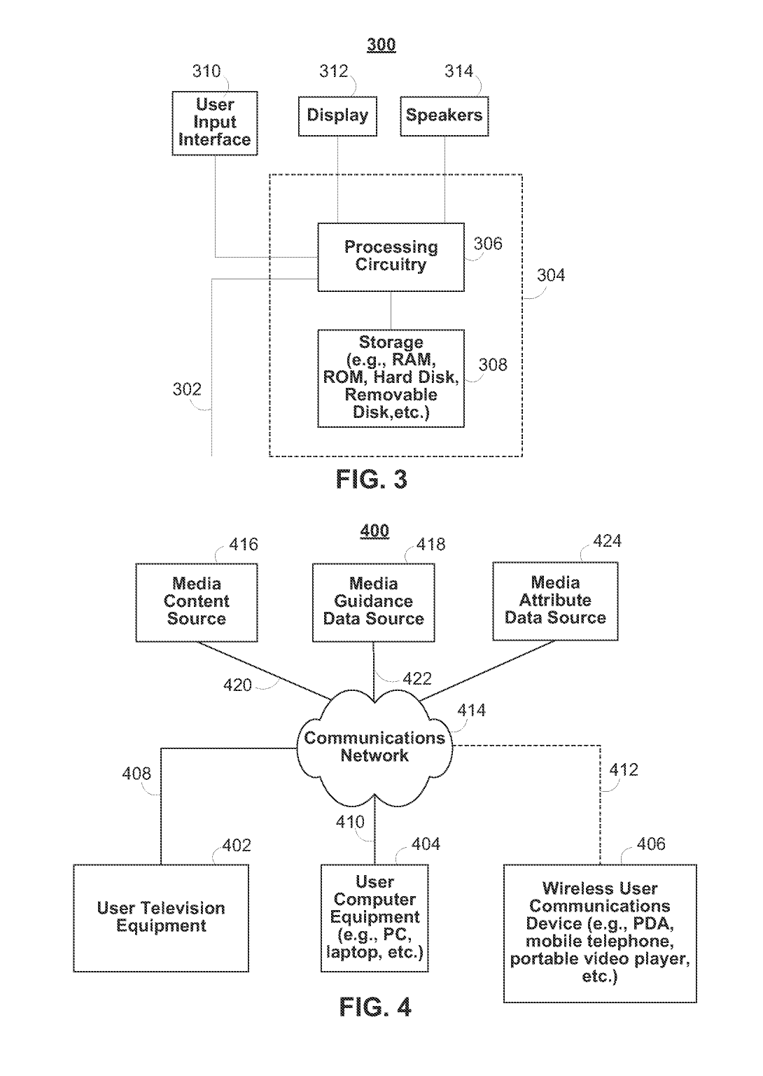

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). In some embodiments, control circuitry 304 executes instructions for retrieving metadata for a selected media asset, identifying attribute metadata and keywords, searching for content related to the media asset based on identified attribute data, determining an ordering scheme for the related content, and/or generating a playlist of the identified content based on the ordering scheme for display to the user.

In client-server based embodiments, control circuitry 304 may include communications circuitry suitable for communicating with a guidance application server or other networks or servers. For example, control circuitry 304 may communicate with a remote server that can search for media attribute data. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308. In some embodiments, memory as described above stores metadata for media assets that may be used to determine media assets and search for related attribute data.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. In some embodiments, the second screen is configured to display recommended media content selected for playback on the first user equipment device. For example, the second screen may display recommended media content requested via recommendation slider user interface 206 on the first user equipment device. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and media attribute data source 424, coupled to communications network 414 via communication paths 420 and 422, respectively. Paths 420 and 422 may include any of the communication paths described above in connection with paths 408, 410, and 412. Communications with the content source 416, media guidance data source 418, and the media attribute data source 424 may be exchanged over one or more communications paths, but are shown as a single path in FIG. 4 to avoid overcomplicating the drawing. In addition, there may be more than one of each of content source 416, media guidance data source 418, and media attribute data source 424, but only one of each is shown in FIG. 4 to avoid overcomplicating the drawing. (The different types of each of these sources are discussed below.) If desired, one or more of content source 416, media guidance data source 418, and media attribute data source 424 may be integrated as one source device. Although communications between sources 416, 418, and 424 with user equipment devices 402, 404, and 406 are shown as through communications network 414, in some embodiments, sources 416, 418, and 424 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media attribute data source 424 may provide attribute data, such as metadata, keywords, genres, and other suitable data described earlier. Media attribute data may be provided to the user equipment devices using any suitable approach. In some embodiments, the guidance application may be a stand-alone interactive television program guide that receives data via a data feed (e.g., a continuous feed or trickle feed). Media attribute data may be provided to the user equipment on a television channel sideband, using an in-band digital signal, using an out-of-band digital signal, or by any other suitable data transmission technique. Media attribute data may be provided to user equipment on multiple analog or digital television channels.

In some embodiments, attribute data from media attribute data source 424 may be provided to users' equipment using a client-server approach. For example, a user equipment device may pull media attribute data from a server, or a server may push media attribute data to a user equipment device. In some embodiments, a guidance application client residing on the user's equipment may initiate sessions with source 424 to obtain attribute data when needed, e.g., when the user equipment device receives a request from the user to receive data. Media attribute data may be provided to the user equipment with any suitable frequency (e.g., continuously, daily, a user-specified period of time, a system-specified period of time, in response to a request from user equipment, etc.). Media attribute data source 424 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance (or attribute) data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance (or attribute) data described above. In addition to content and/or media guidance (or attribute) data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content, guidance, and attribute data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Application Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416, one or more media guidance data sources 418, and one or more media attribute data sources 424. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

FIG. 5 shows an illustrative user interface 500 for generating viewing recommendations based on a seed input. The user interface may be implemented on control circuitry (e.g., control circuitry 304) for an interactive media guidance application (e.g., user interface 206 in FIG. 2), an independent software module or application, or any other suitable format. The seed input may be a media asset received from another viewer, received from the viewer's social network, chosen at random, or any other suitable media asset. The seed input may be a media asset that is disruptive, i.e., having attribute data divergent from the currently viewed program, thereby allowing the viewer to discover new content.

In some embodiments, control circuitry 304 displays one or more media assets to the viewer in user interface 500, and receives a selection of a media asset for the seed input 504. User interface 500 may include slider 506 and affinity indicator 508, and may be displayed on a display such as display 312. Slider 506 varies from a currently viewed media asset 502 on one end to seed input 504 on the other end. Control circuitry 304 may receive user input indicating an updated location for the affinity indicator 508 on the slider 506. For example, control circuitry 304 may receive the updated location via user input interface 310, which may include a remote control device, a pointer device, a touch screen device, or any other suitable input device. The user specified location of the affinity indicator 508 may be used to determine an affinity measure that indicates affinity for the viewed media asset 502 relative to the seed input 504.

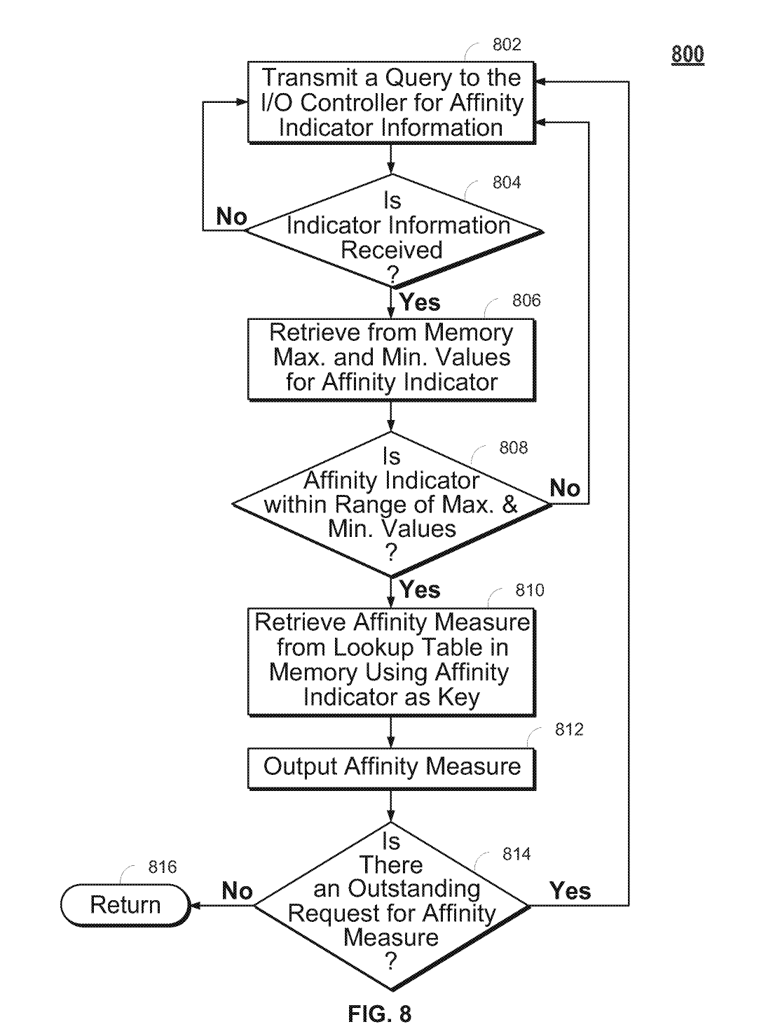

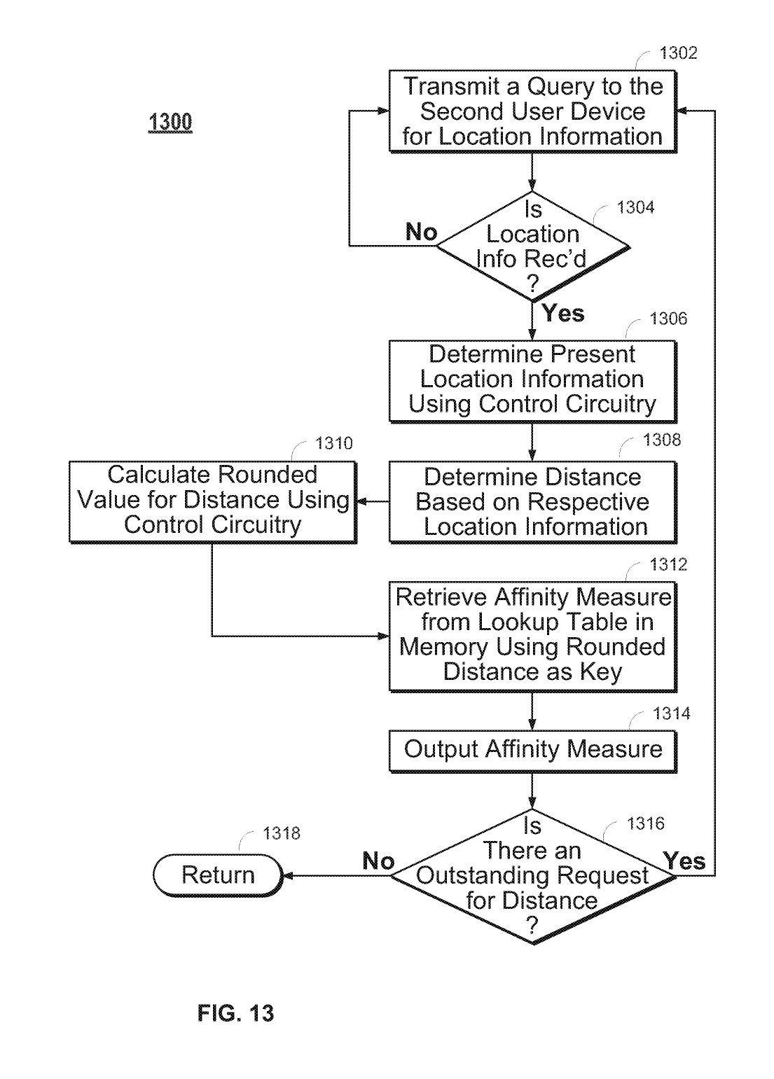

In some embodiments, the affinity measure is a probabilistic measure that weighs the viewed media asset relative to the seed input. The corresponding affinity measure for affinity indicator 508 may be stored in memory (e.g., storage 308) in a lookup table. The lookup table may be indexed using the affinity indicator 508 or some processed version thereof. For example, if the affinity indicator is a whole number, the lookup table may be indexed using the affinity indicator as is. In another example, if the affinity indicator includes a fractional component, the affinity indicator may be processed to compute a rounded value for the affinity indicator before being used to index the lookup table. An illustrative flow diagram for determining the affinity measure from the affinity indicator 508 is described with respect to FIG. 8. In some embodiments, the affinity indicator 508 is retrieved by control circuitry 304 as a preset stored in memory (e.g., storage 308). In some embodiments, the affinity indicator 508 is retrieved by control circuitry 304 based on the distance between a user device having the user interface 500 and another user device. An illustrative flow diagram for a distance-based affinity indicator and affinity measure is described with respect to FIG. 13.

Control circuitry 304 retrieves attribute data for the viewed media asset 502 and the seed input 504 from memory (e.g., storage 308), a remote database (e.g., media attribute data source 424), or any other suitable source. The attribute data may be retrieved from metadata associated with or included within a media asset. In some embodiments, control circuitry 304 may transmit a query to the database or an external remote source (e.g., a website on the Internet) for attribute data for the viewed media asset and/or the seed media asset. In some embodiments, control circuitry 304 retrieves attribute data for the media asset by searching a social network or a blog. For example, control circuitry 304 may search for a social network or blog page (on FACEBOOK, TWITTER, MYSPACE, or any other such websites) relating to the media asset and retrieve metadata and keywords based on posts, links, images, documents, audio, video, or other suitable information included in the social network or blog page.

In embodiments where attribute data for the media asset is determined by searching a social network website or a blog website, control circuitry 304 retrieves login information for the website. Control circuitry 304 may retrieve login information from a user profile, via user input, or in any other suitable manner. In some embodiments, login information is not needed for publicly available webpages on certain social network websites. Control circuitry 304 establishes a communications link with the website via, e.g., the Internet or any other suitable network. Control circuitry 304 transmits a query for attribute data in posts, links, images, documents, audio, video, or other suitable information. For example, control circuitry 304 may find a link to the media asset posted by a friend of the user along with comments reviewing (or describing) an actor starring in the media asset. Control circuitry 304 may retrieve the comments and include the actor's name in attribute data for the media asset.

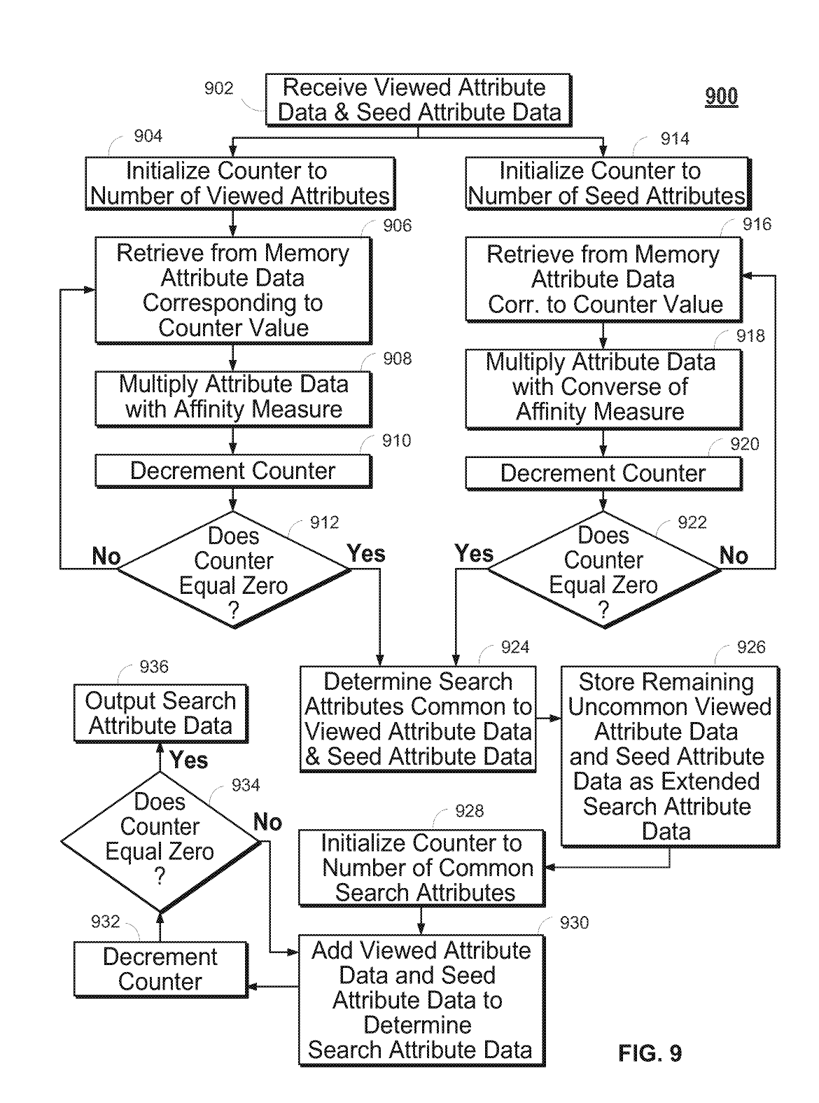

Once attribute data is retrieved, control circuitry 304 applies the affinity measure to the respective attribute data for viewed media 502 and seed input 504. Control circuitry 304 determines search attribute data as a result of the application. The affinity measure applied to attributes common between the viewed media attribute data and the seed media attribute data results in the search attribute data. In some embodiments, attributes that are not common between the viewed media attribute data and the seed media attribute data are stored as extended search attribute data. An illustrative flow diagram for determining the search attribute data is described with respect to FIG. 9.

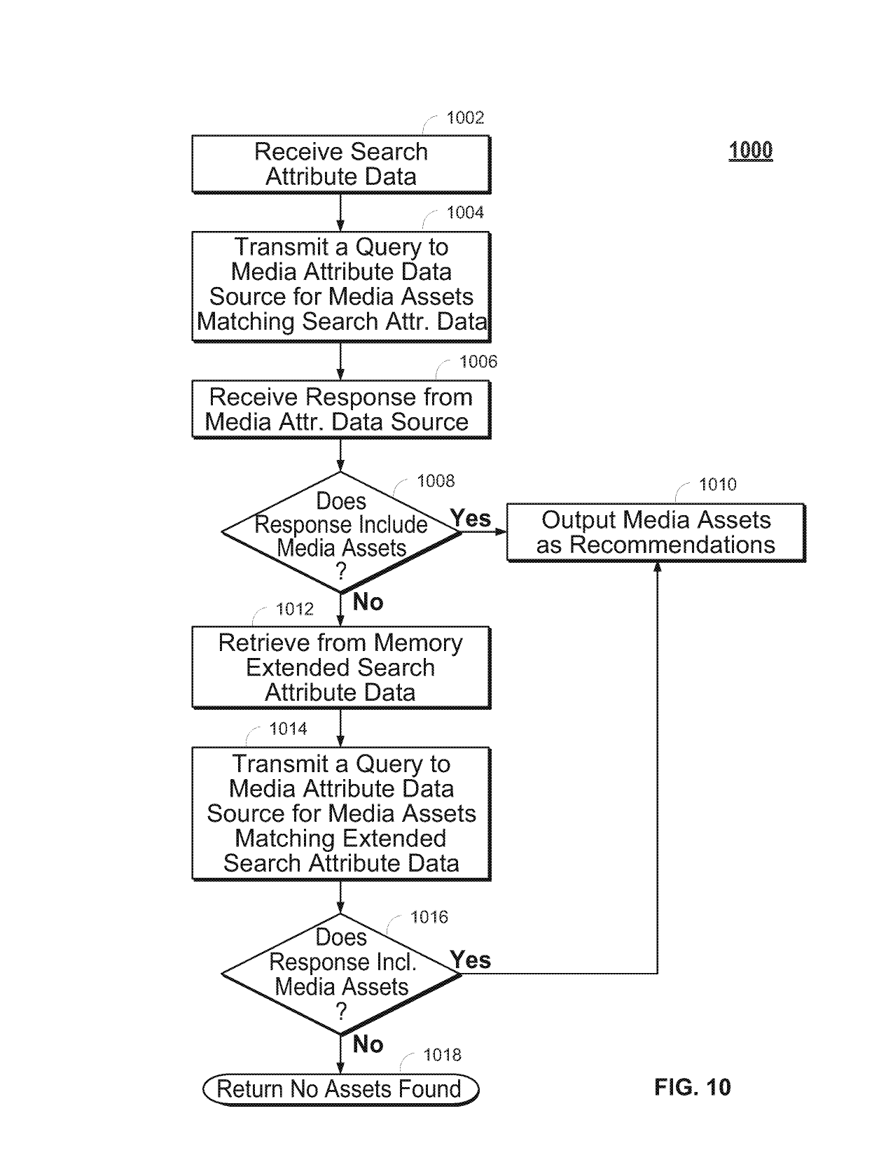

After determining the search attribute data, control circuitry 304 transmits a query to a database (e.g., media content source 416) for media assets matching the search attribute data. Control circuitry 304 may receive in response media assets or links to media assets matching the search attribute data. The media assets may be displayed to the viewer in window 510 of user interface 500. Furthermore, window 512 may display attributes for a recommended media asset to the viewer. Window 512 may optionally display a percentage or similar value for each attribute as specified for the media asset. If no media assets match the search attribute data, control circuitry 304 may transmit an additional query to the database for media assets matching the previously stored extended search attributes. An illustrative flow diagram for generating viewing recommendations is described with respect to FIG. 10. In a similar fashion as described above, control circuitry 304 may display the recommended media assets to the viewer in window 510 and optionally display attributes for a selected media asset in window 512. In some embodiments, control circuitry 304 displays two regions in user interface 500 similar to window 510. The first region may display recommended media assets retrieved based on the search attribute data, while the second region may display recommended media assets retrieved based on the extended search attribute data.

For example, the viewer may currently be viewing an episode of 30 ROCK, an NBC comedy series (owned by NBCUniversal Media LLC). The viewer may receive a seed input for an episode of THE SOPRANOS, an HBO drama series (owned by Home Box Office Inc.) from another viewer via their social network. Control circuitry 304 may display user interface 500 in response to receiving the seed input. Control circuitry 304 may receive an updated location for affinity indicator 508 and determine a corresponding affinity measure. Control circuitry 304 may retrieve attribute data for the viewed asset and the seed input, and determine search attribute data with the aid of the affinity measure. Control circuitry 304 may transmit a query to media content source 416 and receive media assets for recommendation to the viewer, e.g., one or more episodes of DEAD LIKE ME, a SHOWTIME comedy-drama series (owned by Showtime Networks Inc.) sharing characteristics with both 30 ROCK and THE SOPRANOS (e.g., comedy from 30 ROCK and drama from THE SOPRANOS). The viewer may retrieve different viewing recommendations as the affinity indicator 508 slides from one end of the slider 506 to the other. In some embodiments, window 510 (and optionally window 512) may update dynamically as the affinity indicator 508 slides from one end of the slider 506 to the other.

In some embodiments, user interface 500 is displayed to the viewer for generating recommendations similar or dissimilar to the seed input 504. The viewer may receive media asset recommendations similar to the seed input 504 if the affinity indicator 508 is located on one end of the slider 506. Conversely, the viewer may receive media asset recommendations most dissimilar from the seed input 504 (e.g., recommendations for a tragedy movie in view of seed input 504 being a romantic comedy movie) or entirely random media asset recommendations that do not consider the attributes of seed input 504. In this embodiment, control circuitry 304 determines the affinity measure based on the affinity indicator 508, and applies the affinity measure to attribute data for the seed input to form search attribute data. In a similar fashion as described above, control circuitry 304 may display the recommended media assets to the viewer in window 510 and optionally display attributes for a selected media asset in window 512.

For example, the viewer may receive a seed input for an episode of 30 ROCK, an NBC comedy series (owned by NBCUniversal Media LLC) from another viewer via their social network. Control circuitry 304 may display user interface 500 in response to receiving the seed input. The viewer may receive media asset recommendations similar to the seed input 504 if the affinity indicator 508 is located on one end of the slider 506. Control circuitry 304 may receive an updated location for affinity indicator 508 and determine a corresponding affinity measure. Control circuitry 304 may retrieve attribute data for the seed input, and determine search attribute data with the aid of the affinity measure. Control circuitry 304 may transmit a query to media content source 416 and receive media assets for recommendation to the viewer, e.g., one or more episodes of PARKS AND RECREATION, another NBC comedy series (owned by NBCUniversal Media LLC) sharing characteristics with 30 ROCK. The viewer may retrieve different viewing recommendations as the affinity indicator 508 slides from one end of the slider 506 to the other. In some embodiments, window 510 (and optionally window 512) may update dynamically as the affinity indicator 508 slides from one end of the slider 506 to the other.

FIG. 5B shows illustrative user interface 550 for generating viewing recommendations based on a seed input. User interface 550 may provide enhanced control over recommended media assets (compared to user interface 500) by allowing the viewer to selectively vary the contribution of each attribute provided. In some embodiments, user interfaces 500 and 550 are combined to provide a hybrid user interface having both an overall slider interface (FIG. 5A or 5B) and per-attribute sliders (FIG. 5B). The user interface may be implemented on control circuitry (e.g., control circuitry 304) for an interactive media guidance application (e.g., user interface 206 in FIG. 2), an independent software module or application, or any other suitable format. The seed input may be a media asset received from another viewer, received from the viewer's social network, chosen at random, or any other suitable media asset. The seed input may be a media asset that is disruptive, i.e., having attribute data divergent from the currently viewed program, thereby allowing the viewer to discover new content. In some embodiments, control circuitry 304 displays one or more media assets to the viewer in user interface 550, and receives a selection of a media asset for the seed input 554.

User interface 550 may be implemented on control circuitry (e.g., control circuitry 304) for an interactive media guidance application (e.g., user interface 206 in FIG. 2), an independent software module or application, or any other suitable format. User interface 550 may include attribute slider 556A and affinity indicator 558A corresponding to a given attribute, and may be displayed on a display such as display 312. Similarly, user interface 500 may include attribute slider 556B and affinity indicator 558B for another attribute, and so on. The attribute sliders 556 vary from attributes for a currently viewed media asset 552 on one end to seed input 604 on the other end. Control circuitry 304 may receive user input indicating an updated location for one or more of affinity indicators 558 on the attribute sliders 556. For example, control circuitry 304 may receive the updated locations via a user input interface 310, which may include a remote control device, a pointer device, a touch screen device, or any other suitable input device. The user specified locations of the affinity indicators 558 may be used to determine an affinity measure that indicates affinity for the viewed media asset 552 relative to the seed input 554. In some embodiments, control circuitry 304 receives user input deselecting an attribute being considered or inserting an attribute for consideration.

In some embodiments, the affinity measure is a probabilistic measure that weighs the viewed media asset relative to the seed input. The corresponding affinity measure for the provided locations for affinity indicators 558 may be stored in memory (e.g., storage 308) in a lookup table. The lookup table may be indexed using the affinity indicators 558 or some processed version thereof. For example, if the affinity indicator is a whole number, the lookup table may be indexed using the affinity indicator as is. In another example, if the affinity indicator includes a fractional component, the affinity indicator may be processed to compute a rounded value for the affinity indicator before being used to index the lookup table. An illustrative flow diagram for determining the affinity measure from an affinity indicator is described with respect to FIG. 8. In some embodiments, the affinity indicators 558 are retrieved by control circuitry 304 as a preset stored in memory (e.g., storage 308). In some embodiments, the affinity indicators 558 are retrieved by control circuitry 304 based on the distance between a user device having the user interface 550 and another user device. An illustrative flow diagram for a distance-based affinity indicator and affinity measure is described with respect to FIG. 13.

Control circuitry 304 retrieves attribute data for the viewed media asset 552 and the seed input 554 from a database (e.g., media attribute data source 424). The attribute data, including whether certain attributes be considered or not considered, may be retrieved from metadata associated with or included within a media asset. For example, the attribute data for an attribute that should not be considered may include a zero value for the attribute. In some embodiments, control circuitry 304 may search the database or an external remote source (e.g., a website on the Internet) for attribute data for the media asset. In some embodiments, control circuitry 304 retrieves attribute data for the media asset by searching a social network or a blog. For example, control circuitry 304 may search for a social network or blog page (on FACEBOOK, TWITTER, MYSPACE, or any other such websites) relating to the media asset and retrieve keywords and/or metadata based on posts, links, images, documents, audio, video, or other suitable information included in the social network or blog page.

In embodiments where attribute data for the media asset is determined by searching a social network website or a blog website, control circuitry 304 retrieves login information for the website. Control circuitry 304 may retrieve login information from a user profile, via user input, or in any other suitable manner. In some embodiments, login information is not needed for publicly available webpages on certain social network websites. Control circuitry 304 establishes a communications link with the website via, e.g., the Internet or any other suitable network. Control circuitry 304 transmits a query for attribute data in posts, links, images, documents, audio, video, or other suitable information. For example, control circuitry 304 may find a link to the media asset posted by a friend of the user along with comments reviewing (or describing) an actor starring in the media asset. Control circuitry 304 may retrieve the comments and include the actor's name in attribute data for the media asset.

Once attribute data is retrieved, control circuitry 304 applies the affinity measure to the respective attribute data for viewed media 552 and seed input 554. Control circuitry determines search attribute data as a result of the application. The affinity measure applied to attributes common between the viewed media attribute data and the seed media attribute data results in the search attribute data. In some embodiments, attributes that are not common between the viewed media attribute data and the seed media attribute data are stored as extended search attribute data. An illustrative flow diagram for determining the search attribute data is described with respect to FIG. 9.

After determining the search attribute data, control circuitry 304 transmits a query to a database (e.g., media content source 416) for media assets matching the search attribute data. Control circuitry 304 may receive in response media assets or links to media assets matching the search attribute data. The media assets may be displayed to the viewer in window 560 of user interface 550. Furthermore, window 562 may display attributes for a recommended media asset to the viewer. Window 562 may optionally display a percentage or similar value for each attribute as specified for the media asset. If no media assets match the search attribute data, control circuitry 304 may transmit an additional query to the database for media assets matching the previously stored extended search attributes. In a similar fashion as described above, control circuitry 304 may display the recommended media assets to the viewer in window 560 and optionally display attributes for a selected media asset in window 562.

In some embodiments, control circuitry 304 displays two regions in user interface 550 similar to window 560. The first region may display recommended media assets retrieved based on the search attribute data, while the second region may display recommended media assets retrieved based on the extended search attribute data. The viewer may retrieve different viewing recommendations as the affinity indicators 558 slide in varying combinations from one end of the attribute sliders 556 to the other. In some embodiments, window 560 (and optionally window 562) may update dynamically as the affinity indicators 558 slide in varying combinations from one end of the attribute sliders 556 to the other.

For example, the viewer may currently be viewing an episode of 30 ROCK, an NBC comedy series (owned by NBCUniversal Media LLC). The viewer may receive a seed input for an episode of THE SOPRANOS, an HBO drama series (owned by Home Box Office Inc.) from another viewer via their social network. Control circuitry 304 may display user interface 550 in response to receiving the seed input. Control circuitry 304 may retrieve attribute data for the viewed asset and the seed input, transmit a query to media content source 416, and receive media assets for recommendation to the viewer, e.g., one or more episodes of DEAD LIKE ME, a SHOWTIME comedy-drama series (owned by Showtime Networks Inc.) sharing characteristics with both 30 ROCK and THE SOPRANOS (e.g., comedy from 30 ROCK and drama from THE SOPRANOS).

However, the viewer may realize that DEAD LIKE ME is intended for a mature audience, and may instead retrieve viewing recommendations appropriate for a younger audience by sliding the affinity indicator for the ratings attribute towards 30 ROCK (which is more appropriate for a younger audience than THE SOPRANOS). As a result, control circuitry may process and receive media assets for recommendation to the viewer, e.g., one or more episodes of ARRESTED DEVELOPMENT, a FOX comedy-drama series (owned by Fox Entertainment Group) sharing characteristics with both 30 ROCK and THE SOPRANOS (e.g., comedy from 30 ROCK and drama from THE SOPRANOS), yet appropriate for viewing by a younger audience. In some embodiments, window 510 (and optionally window 512) may update dynamically as the affinity indicator slides from one end of the slider to the other.

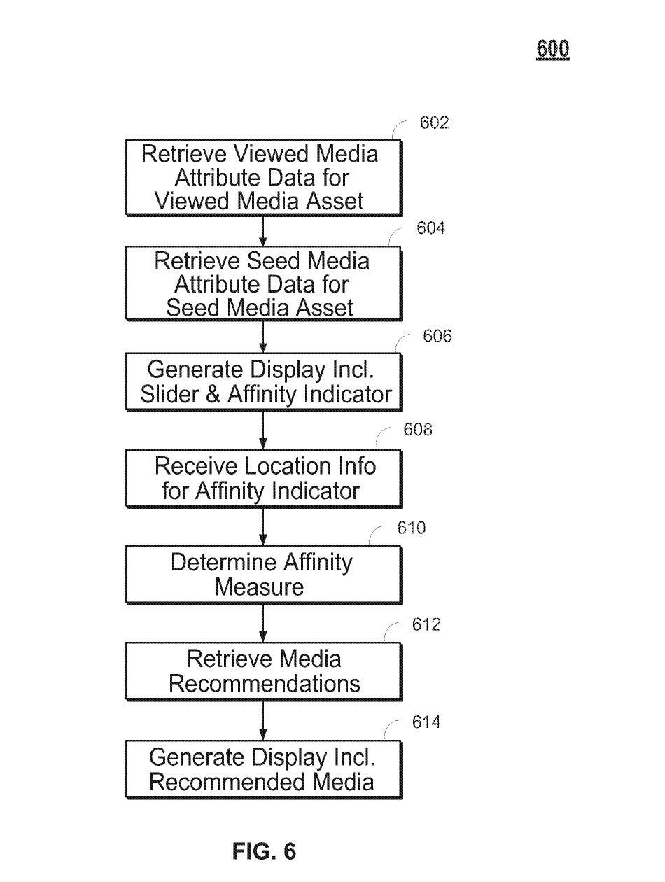

FIG. 6 shows an illustrative flow diagram 600 for generating viewing recommendations via user interfaces such as those described with respect to FIGS. 5A and 5B. At step 602, control circuitry 304 (included in a user device, e.g., in one of user television equipment 402, user computer equipment 404, wireless user device 406, or another suitable user device) retrieves attribute data representative of a media asset currently being viewed by the viewer (e.g., viewed media 502 or 552). Control circuitry 304 may retrieve the viewed media attribute data from memory (e.g., storage 308), a remote database, or any other suitable source. In some embodiments, control circuitry 304 may transmit a query to the database or an external remote source (e.g., a website on the Internet) for attribute data for the media asset.

At step 604, control circuitry 304 retrieves attribute data representative of a seed input including a media asset (e.g., seed input 504 or 554). The seed input may be a media asset having attribute data divergent from the currently viewed program, thereby allowing the viewer to discover new content. The seed input may be a media asset received from another viewer, received from the viewer's social network, chosen at random, or any other suitable media asset. Control circuitry 304 may retrieve the seed media attribute data from memory (e.g., storage 308), a remote database, or any other suitable source. In some embodiments, control circuitry 304 may transmit a query to the database or an external remote source (e.g., a website on the Internet) for attribute data for the media asset.

At step 606, control circuitry 304 generates a display having a slider and an affinity indicator (e.g., user interface 500 or 550). The slider includes a first end associated with the viewed media asset and a second end associated with the seed media asset. The affinity indicator proximate to one of the first and second ends indicates affinity for the viewed media asset relative to the seed input.

At step 608, control circuitry 304 receives location information for the affinity indicator. In some embodiments, the affinity indicator's location (e.g., affinity indicator 508 or 558) on a slider interface (e.g., slider 506 or 556) having the viewed media asset on one end and the seed input on the other end may be used to determine an affinity measure. In some embodiments, the affinity indicator 508 retrieved by control circuitry 304 as a preset stored in memory (e.g., storage 308). In some embodiments, the affinity indicator 508 is retrieved by control circuitry 304 based on the distance between two user devices. An illustrative flow diagram for a distance-based affinity indicator and affinity measure is described with respect to FIG. 13.

At step 610, control circuitry 304 determines the affinity measure for the received location information of the affinity indicator. The corresponding affinity measure for the given affinity indicator location may be stored in memory (e.g., storage 308) in a lookup table. The lookup table may be indexed using the affinity indicator or some processed version thereof. For example, if the affinity indicator is a whole number, the lookup table may be indexed using the affinity indicator as is. In another example, if the affinity indicator includes a fractional component, the affinity indicator may be processed to compute a rounded value for the affinity indicator before being used to index the lookup table. An illustrative flow diagram for determining the affinity measure from the affinity indicator is described with respect to FIG. 8.

At step 612, control circuitry 304 retrieves listings for media recommendations based on the affinity measure determined in step 610. In some embodiments, control circuitry 304 determines search attribute data based on the affinity measure. Control circuitry 304 may apply the affinity measure to the respective attribute data for viewed media asset 502 and seed input 504. Control circuitry 304 may determine the search attribute data as a result of the application. The affinity measure applied to attributes common between the viewed media attribute data and the seed media attribute data results in the search attribute data. Control circuitry 304 may transmit a query to a database (e.g., media content source 416) for media assets matching the search attribute data. Control circuitry 304 may receive in response media assets or links to media assets matching the search attribute data. Illustrative flow diagrams for step 612 are described with respect to FIG. 9 and/or FIG. 10.

At step 614, control circuitry 304 generates a display having viewing recommendations to the viewer on a display (e.g., display 312). For example, control circuitry 304 may display the viewing recommendations to the viewer in a first window of a user interface (e.g., window 510 or 560). Furthermore, control circuitry 304 may display attributes for a recommended media asset in a second window (e.g., window 512 or 562). Control circuitry 304 may generate a display a percentage or similar value for each attribute as specified for the media asset.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, step 608 may be deleted or each of the steps described in relation to FIG. 6 may be performed in any order or in parallel or substantially simultaneously to reduce lag or increase the speed of the system or method.

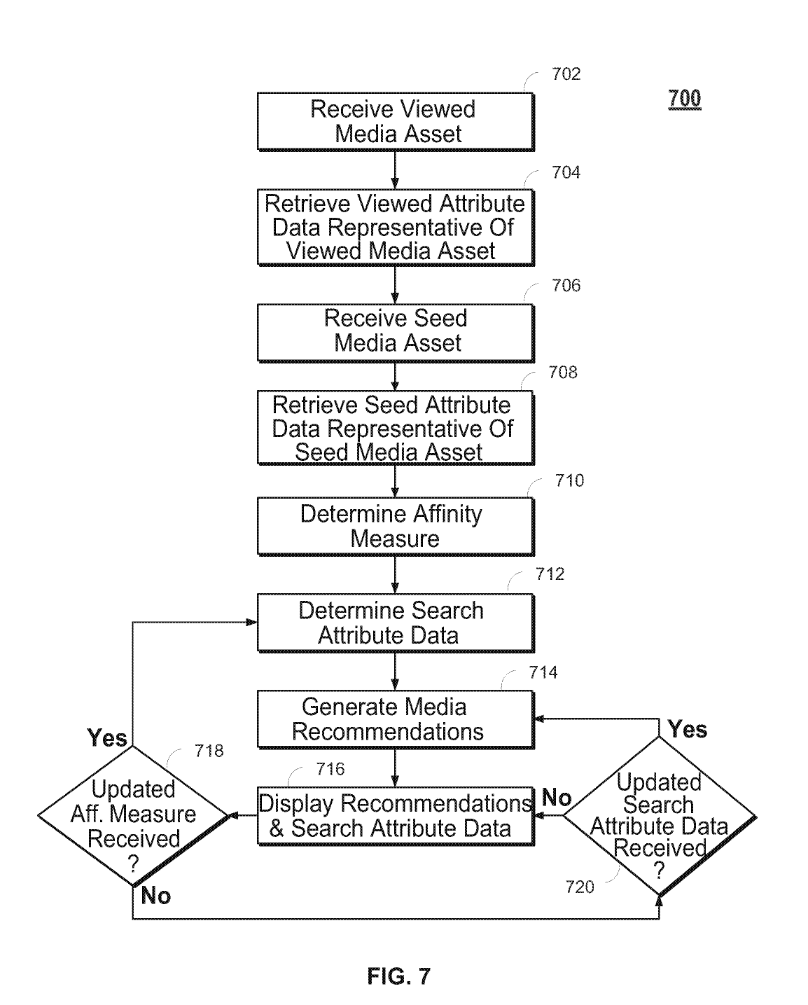

FIG. 7 shows an illustrative flow diagram 700 for generating viewing recommendations via user interfaces such as those described with respect to FIGS. 5A and 5B. At step 702, control circuitry 304 (included in a user device, e.g., in one of user television equipment 402, user computer equipment 404, wireless user device 406, or another suitable user device) receives a media asset currently being viewed by the viewer (e.g., viewed media 502 or 552). At step 704, control circuitry 304 retrieves attribute data representative of the media asset. Control circuitry 304 may retrieve the viewed media attribute data from memory (e.g., storage 308), a remote database, or any other suitable source. In some embodiments, control circuitry 304 may transmit a query to the database or an external remote source (e.g., a website on the Internet) for attribute data for the media asset.

At step 706, control circuitry 304 receives a seed input including a media asset (e.g., seed input 504 or 554). The seed input may be a media asset that is disruptive, i.e., having attribute data divergent from the currently viewed program, thereby allowing the viewer to discover new content. The seed input may be a media asset received from another viewer, received from the viewer's social network, chosen at random, or any other suitable media asset. At step 708, control circuitry 304 retrieves attribute data representative of the media asset. Control circuitry 304 may retrieve the seed media attribute data from memory (e.g., storage 308), a remote database, or any other suitable source. In some embodiments, control circuitry 304 may transmit a query to the database or an external remote source (e.g., a website on the Internet) for attribute data for the media asset.

At step 710, control circuitry 304 determines an affinity measure that indicates affinity for the viewed media asset relative to the seed input. In some embodiments, control circuitry 304 receives an affinity indicator via a user interface (e.g., user interface 500 or 550). The affinity indicator's location (e.g., affinity indicator 508 or 558) on a slider interface (e.g., slider 506 or 556) having the viewed media asset on one end and the seed input on the other end may be used to determine the affinity measure. The corresponding affinity measure for a given affinity indicator location may be stored in memory (e.g., storage 308) in a lookup table. The lookup table may be indexed using the affinity indicator or some processed version thereof. For example, if the affinity indicator is a whole number, the lookup table may be indexed using the affinity indicator as is. In another example, if the affinity indicator includes a fractional component, the affinity indicator may be processed to compute a rounded value for the affinity indicator before being used to index the lookup table. An illustrative flow diagram for determining the affinity measure from the affinity indicator is described with respect to FIG. 8. In some embodiments, the affinity indicator 508 retrieved by control circuitry 304 as a preset stored in memory (e.g., storage 308). In some embodiments, the affinity indicator 508 is retrieved by control circuitry 304 based on the distance between two user devices. An illustrative flow diagram for a distance-based affinity indicator and affinity measure is described with respect to FIG. 13.

At step 712, control circuitry 304 determines search attribute data for retrieving viewing recommendations. Control circuitry 304 applies the affinity measure to the respective attribute data for viewed media 502 and seed input 504. Control circuitry 304 determines the search attribute data as a result of the application. The affinity measure applied to attributes common between the viewed media attribute data and the seed media attribute data results in the search attribute data. In some embodiments, attributes that are not common between the viewed media attribute data and the seed media attribute data are stored as extended search attribute data. An illustrative flow diagram for step 712 is described with respect to FIG. 9.

At step 714, control circuitry 304 generates viewing recommendations for the viewer. Control circuitry 304 may transmit a query to a database (e.g., media content source 416) for media assets matching the search attribute data determined in step 712. Control circuitry 304 may receive in response media assets or links to media assets matching the search attribute data. The media assets may be displayed to the viewer in a user interface (e.g., user interface 500). If no media assets match the search attribute data, control circuitry 304 may transmit an additional query to the database for media assets matching the previously stored extended search attributes from step 712. An illustrative flow diagram for step 714 described with respect to FIG. 10.

At step 716, control circuitry 304 generates a display having viewing recommendations to the viewer on a display (e.g., display 312). For example, control circuitry 304 may display the viewing recommendations to the viewer in a first window of a user interface (e.g., window 510 or 560). Furthermore, control circuitry 304 may display attributes for a recommended media asset in a second window (e.g., window 512 or 562). Control circuitry 304 may generate a display a percentage or similar value for each attribute as specified for the media asset. In some embodiments, control circuitry 304 displays two regions in the user interface similar to the first window. The first region may display recommended media assets retrieved based on the search attribute data, while the second region may display recommended media assets retrieved based on the extended search attribute data as described with respect to step 712 above.

At step 718, control circuitry 304 determines if an updated affinity measure has been received (e.g., via an updated location for the affinity indicator on the slider interface (FIG. 5), an updated distance between user devices, an updated preset, or any other suitable method). If so, control circuitry 304 proceed to step 712. If an updated affinity measure is not detected, control circuitry 304 proceeds to step 720. At step 720, control circuitry 304 determines if updated attribute data has been received (e.g., via an updated location for an affinity indicator on the attribute slider interface (FIG. 5B), an updated distance between user devices, an updated preset, or any other suitable method). If so, control circuitry 304 proceed to step 714. If not, control circuitry 304 returns to the viewing recommendations display.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, step 720 may be deleted or each of the steps described in relation to FIG. 7 may be performed in any order or in parallel or substantially simultaneously to reduce lag or increase the speed of the system or method.

FIG. 8 shows an illustrative flow diagram 800 for determining an affinity measure as indicated in step 610 (FIG. 6) or step 710(FIG. 7). In this embodiment, the affinity measure is determined based on the location of an affinity indicator located on a slider interface. At step 802, control circuitry 304 transmits a query to an input/output controller implemented in the user device displaying the slider interface (e.g., user device 402, 404, 406). In response to the query, control circuitry 304 receives information regarding the location of the affinity indicator on the slider interface. For example, control circuitry 304 may receive the last location where the viewer dragged the indicator on the slider interface. At step 804, control circuitry 304 checks if indicator information is received. If such information is received, control circuitry 304 proceeds to step 806. If not, control circuitry 304 sends another query requesting the affinity indicator information.

At step 806, control circuitry 304 retrieves minimum and maximum values for the affinity indicator. The values may be retrieved from memory (e.g., storage 308) or any other suitable source. At step 808, control circuitry 304 determines whether the received affinity indicator information lies within the range of the minimum and maximum values. If so, control circuitry 304 proceeds to step 810. If not, control circuitry 304 may have received corrupted data and sends another query requesting the affinity indicator information.

At step 810, control circuitry 304 retrieves an affinity measure corresponding to the received affinity indicator from a lookup table stored in memory (e.g., storage 308) using the received affinity indicator as a key. In some embodiments, control circuitry 304 computes the affinity measure from the affinity indicator. For example, if the affinity indicator, i, ranges from −x to x, control circuitry 304 may compute an affinity measure, m, between zero and one using the following equation:

m=(i+x)/2x (1)

At step 812, control circuitry 304 outputs the computed affinity measure. At step 814, control circuitry 304 determines if there is an outstanding request for the affinity measure (e.g., a request for an updated affinity measure in response to updated location information for the affinity indicator on the slider interface (FIG. 5)). If so, control circuitry 304 proceed to step 802. If an outstanding request for the affinity measure is not detected, control circuitry 304 proceeds to step 816. At step 816, control circuitry 304 terminates the affinity measure computation and returns to step 712 indicated in FIG. 7.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, step 808 may be deleted or each of the steps described in relation to FIG. 8 may be performed in any order or in parallel or substantially simultaneously to reduce lag or increase the speed of the system or method.

FIG. 9 shows an illustrative flow diagram 900 for forming search attribute data as indicated in step 712 of FIG. 7. At step 902, control circuitry 304 receives attribute data for both the currently viewed media asset and the seed input. At step 904, control circuitry 304 initializes a counter to the same value as the number of attributes in the viewed media attribute data. At step 906, control circuitry 304 retrieves the viewed media attribute data corresponding to the current counter value, and at step 908, applies the affinity measure to the viewed media attribute data, e.g., by multiplying the affinity measure and the retrieved viewed media attribute data. For example, the viewed media attribute data corresponding to the current counter value may be attribute category “genre” and having attribute value “comedy” and attribute factor “5.” In this example, applying the affinity measure to the viewed media attribute data may include multiplying the affinity measure and the attribute factor. At step 910, control circuitry 304 decrements the counter to proceed to the next attribute in the viewed media attribute data. At step 912, control circuitry 304 checks whether the counter has counted down to zero, which indicates that the affinity measure has been applied to each attribute in the viewed media attribute data. If so, control circuitry 304 proceeds to step 924. Otherwise, control circuitry 304 loops back to step 906 and repeats the application of the affinity measure to the remaining viewed media attribute data.

At step 914, control circuitry 304 initializes a counter to the same value as the number of attributes in the seed media attribute data. At step 916, control circuitry 304 retrieves the seed media attribute data corresponding to the current counter value, and at step 918, applies the converse of the affinity measure to the seed media attribute data. For example, given a range of the affinity measure between zero and one, control circuitry 304 calculates the converse of the affinity measure, m, as (1-m). The converse of the affinity measure, m, may be applied by multiplying (1-m) and the retrieved seed media attribute data. For example, the seed media attribute data corresponding to the current counter value may be attribute category “genre” and having attribute value “drama” and attribute factor “10.” In this example, applying the affinity measure to the seed media attribute data may include multiplying the converse of the affinity measure (i.e., (1-m)) and the attribute factor (i.e., “10”). At step 920, control circuitry 304 decrements the counter to proceed to the next attribute in the seed media attribute data. At step 922, control circuitry 304 checks whether the counter has counted down to zero, which indicates that the affinity measure has been applied to each attribute in the seed media attribute data. If so, control circuitry 304 proceeds to step 924. Otherwise, control circuitry 304 loops back to step 916 and repeats the application of the affinity measure to the remaining seed media attribute data.

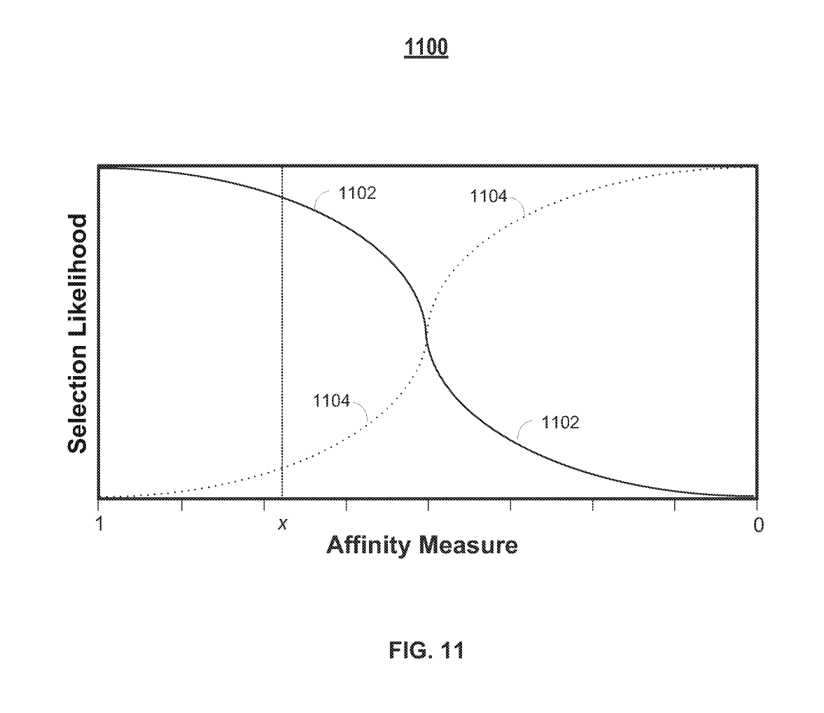

At step 924, control circuitry 304 determines attribute categories common to both the applied viewed media attribute data and the applied seed media attribute data. For example, both attribute data sets may include an attribute data for category “genre.” At step 926, control circuitry 304 stores the remaining uncommon attribute data in memory (e.g., storage 308) as extended search attribute data. For example, only the viewed media attribute data may include attribute category “program rating” (and attribute value “TV-14” and attribute factor “14”), while only the viewed media attribute data may include attribute category “release year” (and attribute value “2002” and attribute factor “2002”). At step 928, control circuitry 304 initializes a counter to the same value as the number of common search attributes and combines the applied viewed media attribute data and the applied seed media attribute data, e.g., by adding the corresponding data. In such an embodiment, the affinity measure, m, is a weight value that is applied to the viewed media attribute data, and converse of the affinity measure, (1-m), is a weight value that is applied to the seed media attribute data. An illustrative embodiment of the weighting process is described with respect to FIG. 11. At step 932, control circuitry 304 decrements the counter, and at step 934, checks whether the counter has counted down to zero. If so, control circuitry 304 outputs the computed data as search attribute data at step 936. Otherwise, control circuitry 304 loops back to step 930 and repeats the combination of the remaining attribute data.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, step 926 may be deleted or each of the steps described in relation to FIG. 9 may be performed in any order or in parallel or substantially simultaneously to reduce lag or increase the speed of the system or method.

FIG. 10 shows an illustrative flow diagram 1000 for retrieving media assets for recommendation as indicated in step 714 of FIG. 7. At step 1002, control circuitry 304 receives search attribute data described with respect to step 712 (FIG. 7). At step 1004, control circuitry 304 transmits a query to a database (e.g., media content source 416, media attribute data source, 424, or any other suitable source) for media assets matching the search attribute data. At step 1006, control circuitry 304 receives a response from the database. The response may include media assets or links to media assets matching the search attribute data. At step 1008, control circuitry 304 checks whether the response includes any such assets. If so, at step 1010, control circuitry 304 outputs the media assets as viewing recommendations. If the response does not include any assets, i.e., no matches are found, at step 1012, control circuitry 304 retrieves extended search attribute data described with respect to step 926 (FIG. 9). At step 1014, control circuitry 304 transmits an additional query to the database for media assets matching the extended search attribute data. Control circuitry 304 receives a response from the database, and at step 1016, control circuitry 304 checks whether the response includes any media assets. If so, at step 1010, control circuitry 304 outputs the media assets as viewing recommendations. If the response does not include any assets, at step 1018, control circuitry 304 returns a message for display stating that no matches were found.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, steps 1012-1016 may be deleted or each of the steps described in relation to FIG. 10 may be performed in any order or in parallel or substantially simultaneously to reduce lag or increase the speed of the system or method.

FIG. 11 shows an illustrative graph 1100 determining seed media attribute data based on likelihood of considering viewed media attribute data relative to seed media attribute data. Curve 1102 depicts the likelihood, P_{V}, of the viewed media attribute data being considered may decrease as the affinity measure moves from one towards zero. For example, the viewed attribute may receive minimal consideration (or minimally weighted) if the affinity measure is close to zero. Conversely, curve 1104 depicts the likelihood, P_{S}, of a corresponding seed media attribute data being considered may decrease as the affinity measure moves from zero towards one. For example, the seed attribute may receive minimal consideration (or minimally weighted) if the affinity measure is close to one. In some embodiments, one or both of curves 1102 and 1104 represent half-portions of a standard bell curve.

In FIG. 11, the viewed media attribute data is maximally weighted if the affinity measure equals one, and the seed attribute is maximally weighted if the affinity measure equals zero. As the affinity measure varies, the weighting on the viewed media attribute data is converse of the weighting on the seed media attribute data. This is because curve 1104 corresponding to the seed media attribute data is appropriately kept out of phase from the curve 1102 corresponding to the viewed media attribute data. For example, given an affinity measure, x, the weighting on the viewed media attribute data is x while the weighting on the seed media attribute data is (1−x). The likelihood for the viewed media attribute data is the area under the curve 1102 to the right of the x line, while the likelihood for the seed media attribute data is the area under the curve 1104 to the left of the x line. The search attribute data, A, based on viewed media attribute data, v, seed media attribute data, s, and affinity measure, x, may be computed using the following equation:

A=x*v+(1−x)*s (2)

For example, the viewed media attribute data, v, may include attribute category “genre” having attribute value “comedy” and attribute factor “5.” The seed media attribute data may also include attribute category “genre” and having attribute value “drama” and attribute factor “10.” In this example, applying the affinity measure, x, to the viewed media attribute data may include multiplying the affinity measure and the attribute factor “5.” Similarly, applying the affinity measure to the seed media attribute data may include multiplying the converse of the affinity measure, (1−x), and the attribute factor “10”. The search attribute data, A, includes attribute category “genre” common to both the viewed media attribute data and seed media attribute data. The corresponding attribute factor may be computed using the following equation:

A=x*5+(1−x)*10 (3)

If the affinity measure gives equal weight to both the viewed media attribute data and the seed media attribute data (i.e., x=0.5), the attribute factor may be computed as (0.5*5+(1−0.5)*10)=7.5. This attribute factor may correspond to attribute value “comedy drama,” which is equally distant from both the viewed media attribute value “comedy” and the seed media attribute value “drama.” As a result, the search attribute data may include attribute category “genre” and having attribute value “comedy drama” and attribute factor “7.5.” In some embodiments, a range of the affinity measure may be applied to capture of wider range for the search attribute data.

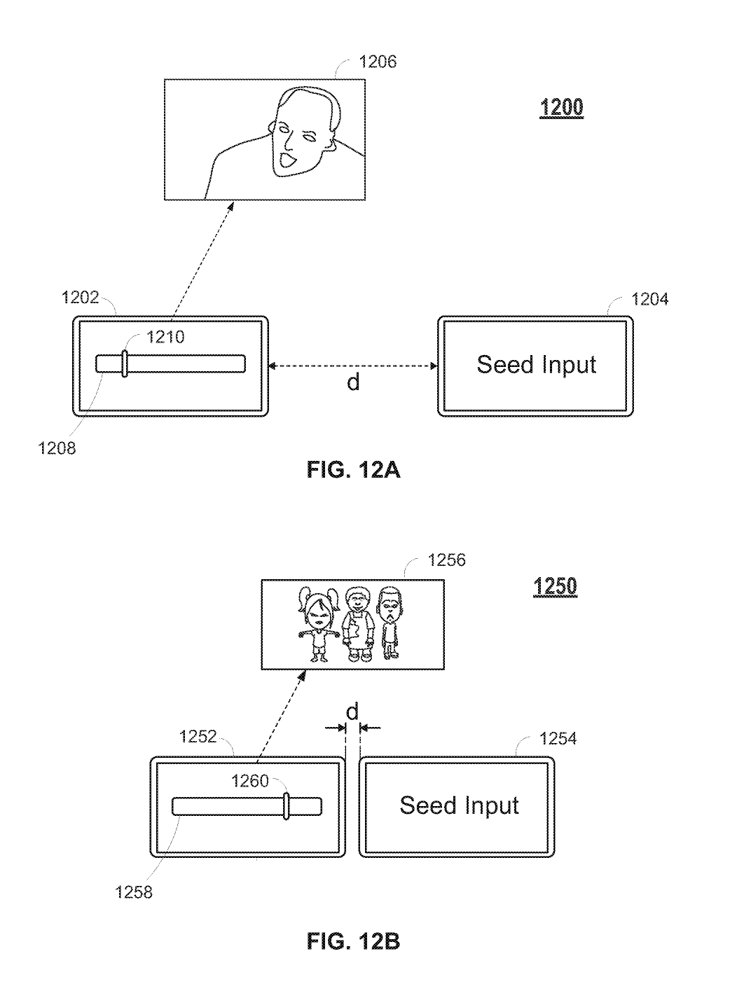

FIGS. 12A and 12B show illustrative diagrams for a system implementing the flow diagram of FIG. 6 or FIG. 7. In FIG. 12A, the system shown includes user device 1202 and user device 1204. Also included is a display 1206. In FIG. 12B, the system shown includes user device 1252 and user device 1254. Also included is a display 1256. In some embodiments, display 1206 (or 1256) is integrated within user device 1202 (or 1252). User devices 1202 (or 1252) and 1204 (or 1254) may be in communication via Internet, a local area network, a BLUETOOTH network, an infrared (IR) network, or any other suitable wired or wireless network. User device 1202 (or 1252) displays a user interface (similar to FIG. 5) for generating viewing recommendations based on a seed input. The user interface may be implemented on control circuitry within user device 1202 (or 1252) (e.g., control circuitry 304). The seed input is received from user device 1204 (or 1254). In some embodiments, the seed input is received from the viewer's social network, chosen at random, or any other suitable media asset. The seed input may be a media asset having attribute data divergent from the currently viewed program, thereby allowing the viewer to discover new content.

User device 1202 (or 1252) displays a user interface having slider 1208 (or 1258) and affinity indicator 1210 (or 1260). Slider 1208 (or 1258) varies from a currently viewed media asset on one end to the seed input on the other end. Control circuitry 304 may receive an instruction including an updated location for the affinity indicator 1210 (or 1260) on the slider 1208 (or 1258). For example, control circuitry 304 may receive the updated location as user device 1204 (or 1254) moves closer to or further away from user device 1202 (or 1252). In another example, control circuitry 304 may receive the updated location as user input. The updated location of the affinity indicator 1210 (or 1260) may be used to determine an affinity measure that indicates affinity for the viewed media asset relative to the seed input. The corresponding affinity measure for affinity indicator 1210 (or 1260) may be stored in memory (e.g., storage 308) in a lookup table. The lookup table may be indexed using the affinity indicator 1210 (or 1260) or some processed version thereof. For example, if the affinity indicator is a whole number, the lookup table may be indexed using the affinity indicator as is. In another example, if the affinity indicator includes a fractional component, the affinity indicator may be processed to compute a rounded value for the affinity indicator before being used to index the lookup table.

In some embodiments, the affinity indicator 1210 (or 1260) is retrieved by control circuitry 304 based on the distance between user device 1202 (or 1252) and user device 1204 (or 1254). As user device 1204 (or 1254) varies in distance d from user device 1202 (or 1252), the affinity measure may be updated accordingly. For example, the affinity measure may be weighted towards the currently viewed media asset on user device 1202 relative to the seed input on user device 1204, if d is large (FIG. 12A). In another example, the affinity measure may be weighted towards the seed input on user device 1254 relative to the currently viewed media asset on user device 1252, if d is small (FIG. 12B).

Control circuitry 304 included in user device 1202 (or 1252) may transmit a query to user device 1204 (or 1254) for location information. The location information may be generated by user device 1204 (or 1254) using an image processing device, a motion sensing device (e.g., MICROSOFT KINECT), a Received Signal Strength Indication (RSSI) device, a global positioning system (GPS) device, a cell tower triangulation device, a WiFi triangulation device, an infrared (IR) tracking device, or any other suitable location tracking device. In the embodiment where user device 1204 (or 1254) uses a motion sensing device, the user device 1204 (or 1254) is not required to be on the viewer's person in order to determine their location. In this embodiment, the location information for the viewer is transmitted to control circuitry 304. In the embodiment where user device 1204 (or 1254) uses a RSSI device, the user device 1204 (or 1254) is initially calibrated and a default RSSI value is stored. In this embodiment, variation in the RSSI value of the user device 1204 (or 1254) as the viewer moves indicates the viewer's location and is transmitted to control circuitry 304.

Upon receipt of the location information for user device 1204 (or 1254), control circuitry 304 may determine location information for user device 1202 (or 1252), and determine the distance between user device 1202 (or 1252) and user device 1204 (or 1254). Control circuitry 304 may retrieve an affinity measure corresponding to the distance from a lookup table stored in memory (e.g., storage 308) using the processed distance value as a key. In some embodiments, control circuitry 304 computes the affinity measure from the distance. An illustrative flow diagram for a distance-based affinity indicator and affinity measure is described with respect to FIG. 13.

After determining the affinity measure, control circuitry 304 may retrieve attribute data for the viewed media asset and the seed input from memory (e.g., storage 308), a remote database (e.g., media attribute data source 424), or any other suitable source. The attribute data may be retrieved from metadata associated with or included within a media asset. In some embodiments, control circuitry 304 may transmit a query to the database or an external remote source (e.g., a website on the Internet) for attribute data for the media asset. In some embodiments, control circuitry 304 retrieves attribute data for the media asset by transmitting a query to a social network or a blog. For example, control circuitry 304 may search for a social network or blog page (on FACEBOOK, TWITTER, MYSPACE, or any other such websites) relating to the media asset and retrieve metadata and keywords based on posts, links, images, documents, audio, video, or other suitable information included in the social network or blog page.

Once attribute data is retrieved, control circuitry 304 applies the affinity measure to the respective attribute data for the viewed media and the seed input. Control circuitry 304 determines search attribute data as a result of the application. The affinity measure applied to attributes common between the viewed media attribute data and the seed media attribute data results in the search attribute data. In some embodiments, attributes that are not common between the viewed media attribute data and the seed media attribute data are stored as extended search attribute data. An illustrative flow diagram for determining the search attribute data is described with respect to FIG. 9.

After determining the search attribute data, control circuitry 304 transmits a query to a database (e.g., media content source 416) for media assets matching the search attribute data. Control circuitry 304 may receive in response media assets or links to media assets matching the search attribute data. The media assets may be displayed to the viewer on user device 1202 (or 1252). If no media assets match the search attribute data, control circuitry 304 may transmit an additional query to the database for media assets matching the stored extended search attributes. An illustrative flow diagram for generating viewing recommendations is described with respect to FIG. 10.

In an exemplary embodiment of the system described in FIGS. 12A and 12B, user device 1202 or 1252 receives location information from user device 1204 or 1254 to aid in generating movie recommendations for viewers of the user devices. User device 1252 may receive location information from user device 1254 and determine that the distance matches the expected range for “in a relationship” (FIG. 12B) because the viewers for user devices 1252 and 1254 are sitting very close together. Accordingly, user device 1252 may display viewing recommendations that couples generally would watch together, e.g., romantic movies. In another exemplary embodiment, user device 1202 may determine that the distance between user devices 1202 and 1204 (or viewers for user devices 1202 and 1204) matches the expected range for “friends” (FIG. 12A) (e.g., sitting further apart than those in a relationship). Accordingly, the user device 1202 may display viewing recommendations that friends generally would watch together, e.g., comedy movies. In some embodiments, user device 1202 or 1252 corroborates the determined viewer relationship based on distance between the respective user devices via a query to a database or a social network. In some embodiments, multiple user devices interact with each other and the respective distances may be used to provide viewing recommendations for the group of viewers. In some embodiments, one user device may be indicated as an anchor device that performs the necessary distance calculations and generates viewing recommendations accordingly.

FIG. 13 shows an illustrative flow diagram 1300 for determining an affinity measure as indicated in step 610 (FIG. 6) or step 710 (FIG. 7). In this embodiment, the affinity measure is determined based on the distance between two user devices, e.g., the devices described with respect to FIGS. 12A and 12B. The described system and method may be implemented in the system of FIGS. 12A and 12B for generating viewing recommendations.

At step 1302, control circuitry 304 (included in the first user device) transmits a query to the second user device for location information. The location information may be generated by the second user device using an image processing device, a motion sensing device (e.g., MICROSOFT KINECT), a Received Signal Strength Indication (RSSI) device, a global positioning system (GPS) device, a cell tower triangulation device, a WiFi triangulation device, an infrared (IR) tracking device, or any other suitable location tracking device. At step 1304, control circuitry 304 confirms whether location information has been received. Control circuitry 304 may additionally confirm whether the location information is uncorrupted. For example, if the location information is outside a certain range from the last known device location, the location information may have been corrupted. If so, control circuitry 304 may loop to step 1302 and transmit another query to the second user device. Otherwise, control circuitry 304 proceeds to step 1306.

At step 1306, control circuitry 304 determines location information for the first user device. The location information may be generated by the first user device using an image processing device, a motion sensing device (e.g., MICROSOFT KINECT), a Received Signal Strength Indication (RSSI) device, a global positioning system (GPS) device, a cell tower triangulation device, a WiFi triangulation device, or any other suitable location tracking device. Control circuitry 304 may confirm whether the location information is uncorrupted and recompute the location information in case of any discrepancies. At step 1308, control circuitry 304 determines the distance between the first user device and the second user device based on their respective location information. At step 1310, control circuitry 304 optionally computes a rounded value for the distance or any other suitable transformation as needed. For example, control circuitry 304 may round the distance (in inches or centimeters) to the nearest integer value. At step 1312, control circuitry 304 retrieves an affinity measure corresponding to the distance from a lookup table stored in memory (e.g., storage 308) using the processed distance value as a key. In some embodiments, control circuitry 304 computes the affinity measure from the distance. For example, if the distance, d, ranges from −x to x, control circuitry 304 may compute an affinity measure, m, between zero and one using the following equation:

m=(d+x)/2x (4)

At step 1314, control circuitry 304 outputs the computed affinity measure. At step 1316, control circuitry 304 determines if there is an outstanding request for the affinity measure (e.g., a request for an updated affinity measure in response to updated location information for the affinity indicator on the slider interface (FIG. 5A or 5B)). If so, control circuitry 304 proceed to step 1302. If an outstanding request for the affinity measure is not detected, control circuitry 304 proceeds to step 1318. At step 1318, control circuitry 304 terminates the affinity measure computation and returns to step 712 indicated in FIG. 7.

It is contemplated that the steps or descriptions of FIG. 13 may be used with any other embodiment of this disclosure. In addition, the steps and descriptions described in relation to FIG. 13 may be done in alternative orders or in parallel to further the purposes of this disclosure. For example, step 1310 may be deleted or each of the steps described in relation to FIG. 13 may be performed in any order or in parallel or substantially simultaneously to reduce lag or increase the speed of the system or method.

It will be appreciated that while the discussion of media content has focused on video content, the principles of media guidance can be applied to other types of media content, such as music, images, etc.

The foregoing is merely illustrative of the principles of the systems and methods described herein, and various modifications can be made by those skilled in the art without departing from the scope and spirit of the systems and methods described herein. The above described embodiments are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel.

1. A method for generating viewing recommendations, comprising:
retrieving, from a memory, viewed media attribute data representative of a media asset being currently viewed;
retrieving, from the memory, seed media attribute data representative of a seed media asset;
generating, using control circuitry, a display including a slider, wherein the slider includes a first end associated with the viewed media asset, a second end associated with the seed media asset, and an affinity indicator proximate to one of the first and second ends;
receiving location information of the affinity indicator on the slider;
determining, using control circuitry, an affinity measure based on the location information of the affinity indicator, wherein the affinity measure indicates affinity for the viewed media asset relative to the seed media asset;
retrieving listings for media assets based on the affinity measure; and
generating, using control circuitry, a display including the listings for the media assets.

2. The method of claim 1, wherein retrieving the listings for the media assets based on the affinity measure comprises:
applying the affinity measure to the viewed media attribute data and converse of the affinity measure to the seed media attribute data; and
combining results of the applications to form search attribute data.

3. The method of claim 2, further comprising:
transmitting a query to a database for media assets matching the search attribute data;
receiving the media assets from the database; and
generating the display including the media assets and the search attribute data.

4. The method of claim 1, wherein retrieving seed media attribute data representative of the seed media asset comprises:
retrieving metadata associated the seed media asset; and
determining the seed media attribute data based on the retrieved metadata.

5. The method of claim 1, wherein the location information of the affinity indicator is based on a distance between a first user device associated with the viewed media asset and a second user device associated with the seed media asset.

6. The method of claim 5, wherein the media assets and the search attribute data are displayed on a display device associated with the first user device.

7. The method of claim 1, wherein determining the affinity measure based on the location information of the affinity indicator on the slider comprises:
retrieving the affinity measure from a lookup table indexed using the affinity indicator.

8. The method of claim 2, comprising:
determining an updated affinity measure based on updated location information of the affinity indicator;
forming updated search attribute data based on the updated affinity measure, the viewed media attribute data, and the seed media attribute data;
determining search attributes common to the applied viewed media attribute data and the applied seed media attribute data; and
adding respective data from the applied viewed media attribute data and the applied seed media attribute data to form the search attribute data.

9. The method of claim 8, further comprising:
storing attribute data not common to the applied viewed media attribute data and the applied seed media attribute data as extended search attribute data;
adding respective data from the applied viewed media attribute data and the applied seed media attribute data to form the extended search attribute data;
generating a display including a first region including media assets matching the search attribute data; and
generating a display including a second region including media assets matching the extended search attribute data.

10. The method of claim 1, wherein the seed media asset includes one of a media asset received from an individual, a media asset received from a social network, and a randomly chosen media asset.

11. A system for generating viewing recommendations, comprising control circuitry configured to:
retrieve, from a memory, viewed media attribute data representative of a media asset being currently viewed;
retrieve, from the memory, seed media attribute data representative of a seed media asset;
generate a display including a slider, wherein the slider includes a first end associated with the viewed media asset, a second end associated with the seed media asset, and an affinity indicator proximate to one of the first and second ends;
receive location information for the affinity indicator on the slider;
determine an affinity measure based on the location information of the affinity indicator, wherein the affinity measure indicates affinity for the viewed media asset relative to the seed media asset;
retrieve listings for media assets based on the affinity measure; and
generate a display including the listings for the media assets.

12. The system of claim 11, wherein the control circuitry configured to retrieve the listings for the media assets based on the affinity measure comprises the control circuitry further configured to:
apply the affinity measure to the viewed media attribute data and converse of the affinity measure to the seed media attribute data; and
combine results of the applications to form search attribute data.

13. The system of claim 12, wherein the control circuitry is further configured to:
transmit a query to a database for media assets matching the search attribute data;
receive the media assets from the database; and
generate the display including the media assets and the search attribute data.

14. The system of claim 11, wherein the control circuitry configured to retrieve seed media attribute data representative of the seed media asset comprises the control circuitry configured to:
retrieve metadata associated the seed media asset; and
determine the seed media attribute data based on the retrieved metadata.

15. The system of claim 11, wherein the location information of the affinity indicator is based on a distance between a first user device associated with the viewed media asset and a second user device associated with the seed media asset.

16. The system of claim 15, wherein the media assets and the search attribute data are displayed on a display device associated with the first user device.

17. The system of claim 11, wherein the control circuitry configured to determine the affinity measure based on the location information of the affinity indicator on the slider comprises the control circuitry configured to:
retrieve the affinity measure from a lookup table indexed using the affinity indicator.

18. The system of claim 12, the control circuitry configured to:
determine an updated affinity measure based on updated location information of the affinity indicator;
form updated search attribute data based on the updated affinity measure, the viewed media attribute data, and the seed media attribute data;
determine search attributes common to the applied viewed media attribute data and the applied seed media attribute data; and
add respective data from the applied viewed media attribute data and the applied seed media attribute data to form the search attribute data.

19. The system of claim 18, comprising the control circuitry further configured to:
store attribute data not common to the applied viewed media attribute data and the applied seed media attribute data as extended search attribute data;
add respective data from the applied viewed media attribute data and the applied seed media attribute data to form the extended search attribute data;
generate a display including a first region including media assets matching the search attribute data; and
generate a display including a second region including media assets matching the extended search attribute data.

20. The system of claim 11, wherein the seed media asset includes one of a media asset received from an individual, a media asset received from a social network, and a randomly chosen media asset.

21-30. (canceled)
